(19) United States
(12) Patent Application Publication
(10) Pub. No.: US 2005/0094724 A1
(43) Pub. Date: May 5, 2005

(54) Method for transmitting video and the device thereof

(75) Inventor: Chang-Hung Lee, TouNan Town (TW)

Correspondence Address: TROXELL LAW OFFICE PLLC;SUITE 1404, 5205 LEESBURG PIKE, FALLS CHURCH, VA, 22041, US

(73) Assignee: BENQ Corporation

(21) Appl. No.: 10/975,354

(22) Filed: Oct. 29, 2004

(30) Foreign Application Priority Data
Oct. 31, 2003 (TW) 92130372

(51) Int. Cl. H04N 7/12

(52) U.S. Cl. 375/240.01

(57) ABSTRACT

This present invention provides a method for transmitting video, comprising the steps of: selecting a compression format for transmitting the video frames by a decision process; compressing said video data by said compression format to produce a corresponding video compressed data; generating a control code with respect to said video compressed data and said compression format; and transmitting said video compressed data and said control code to a receiving device. The method of this invention decides the compression format for transmitting the video first and then processes the compression and transmission in order to provide better transmitting quality.

### FIELD OF THE INVENTION

The present inventions relate to a method for transmitting video and the device thereof, and more particularly, to a method for transmitting video and the device thereof capable of providing different compression formats for matching with different video data in order to provide better transmission quality.

### BACKGROUND OF THE INVENTION

With the continuous progress of wireless communication technology, people's wish for wireless communication come true. The wireless products replace the wire product to get rid of constraint of wire eventually and free for users, such as wireless transmission of multimedia. However, the broadband LAN cannot satisfy people's demand, especially for multimedia which needs larger bandwidth than ever. Thus, compression for data is essential for multimedia communication. In our life with universal information currency, the demand for multimedia has become more and more so the digitalization of video is necessary. However, the amount of digitalized video data is pretty huge and very inconvenient for wireless transmitting and processing. Therefore, the data compression is the best way to save the transmission bandwidth. However, there is no compression method can provide good quality for all kinds of video signal. To overcome the problems, the present invention provides a method for transmitting video and the device thereof which can adaptively choose different compression formats for different kind data in one video, reduce the amount of transmitting data and get better quality of received video.

### SUMMARY OF THE INVENTION

It is therefore an object of this present invention to provide a method for transmitting video and the device thereof capable of utilizing different compression formats to compress video data, such that the amount of video data transmitted is reduced and the image quality is enhanced.

To achieve the above-noted goal, the invention provides a method for transmitting video, comprising the steps of: selecting a compression format for the video frame to be transmitted using a decision process; compressing the frames using the compression format and producing the corresponding video compressed data; processing the video compressed data to produce a control code corresponding to the video compressed data, compression time and parameters of the compression format; and transmitting the video compressed data and the control code to a receiving device.

The inventions also provide a device for transmitting video, comprising: a video unit, a processing unit, and a transmitting unit. The video unit can be a storage unit for storing/transmitting a video, or a video receiving unit for transmitting a video having a plurality of frames. The processing unit is coupled to the video unit receives the video for receiving the video, capturing continuous frames, and selecting a proper compression format according to the detecting condition from the frames, and then producing the compressed video data corresponding to the compression format. The transmitting unit is connected to the processing unit for transmitting the video compressed data and the control code to the receiving device.

The above and other objects and the advantages and features of the present inventions will be more apparent from the detailed description of preferred embodiments, taken in conjunction with the drawings.

### BRIEF DESCRIPTION OF THE DRAWINGS

FIG. 1 is a schematic view of the preferred embodiment of wireless transmission system of the present invention in use.

FIG. 2 is a flow diagram of the method of the present invention in use.

FIG. 3 is a schematic view of the preferred embodiment of the video data of the present invention in use.

### DESCRIPTION OF THE PREFERRED EMBODIMENT

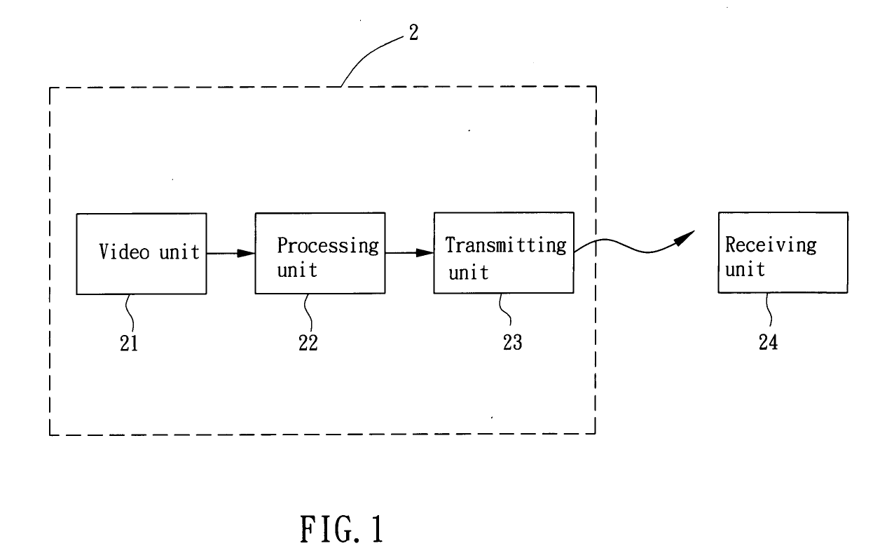

Referring to FIG. 1, which is a schematic view of the preferred embodiment of a device for transmitting video data of this invention. Device 2 is configured for transmitting video, such as video, still image or animation, to a receiving device 24 in which the connecting method is wire/wireless connecting. The receiving device 24 is a projector, a computer, or other kinds of video display device. Device 2 comprises a video unit 21, a processing unit 22, and a transmitting unit 23. The video unit 21 is a Video Graphics Adapter (hereafter VGA), a video receiver also preferred, such as cable television receiver or video storage, being configured for storing video data for being transmitted, such as DVD player. The video data includes a plurality of frames, such as the first frame, the second frame, the third frame . . . and so on. The processing unit 22 can capture the frame in the video data from the video unit 21, decide the compression format for the frame, compress the frame by the compression format, and then produce the relative compressed video data. The processing unit 22 estimates the change of two adjacent frames by which the necessary compression format can be decided, the change is an image variation between two frames. For example, the processing unit 22 captures the first frame and the second frame and calculates the image change of those two in order to decide the compression format and compress the frame data through this compressed data for producing video compressed data. If the frame change is smaller than the first reference data, the frames will be compressed by the first compression format; if the frame change is between the first reference data and the second reference data wherein the second reference data is larger than the first reference data, the frames will be compressed by a second compression format; if the frame change is larger than the second reference data, the frames will be compressed by a third compression format. The processing unit 22 produces a control code while transmitting video compressed data. The transmitting unit 23 transmits the video compressed data and the control code to the receiving device 24 wherein the control code is for the receiving device 24 to judge the compression format of the video compressed data in order to process the relative decompressing process. The control code comprises parameters relative to the compression format and a compression time relative to the compressed data. After receiving the video compressed data, the receiving device 24 can judge compression format of the video compressed data and the relative time through the control code, and then process the relative decompression to return the video compressed data back to the original frame data.

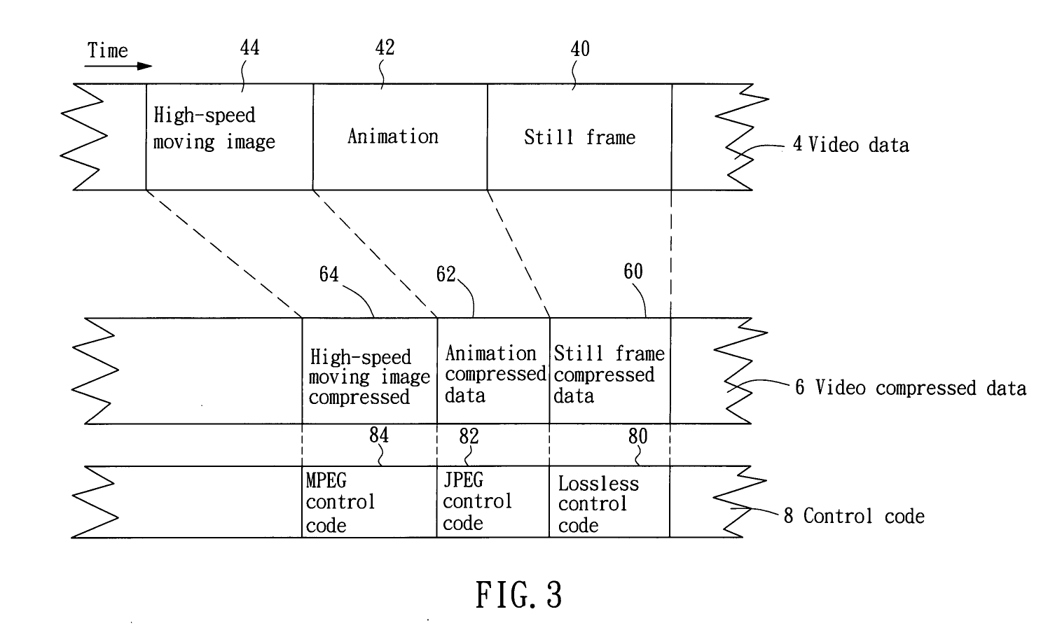

Referring to FIG. 3, the video data 4 transmitted from the video unit 21 to the processing unit 22 have different kinds of video types. Some video is high-speed moving image 44 which changes frames with high-speed; some is animation 42 which changes less frames; and some will be still frame 40. Because the frames in video data have different change and each kind of compression format has different advantages and disadvantages for different frames, the quality of frames can be improved and the transmitting path can be used effetely if different ways can be used for different kinds of frames and then compress video data. In FIG. 3, after a first frame and a second frame of the video data 4 are received by the process device 22, the video data 4 is detected to be one of the still frames 40, animation 42 and high-speed moving image 44 according the difference of the first frame and the second frame. By choosing better relative compression format, such as MPEG compression, Motion JPEG compression, or the compression format of the still frame harmless to the frame quality, and getting the relative video compressed data 6 and control code 8, the processing unit 22 transfers the video compressed data 6 and control code 8 to the transmitting unit 23 and then transmits to the receiving device 24 by wire/wireless way. After receiving the video compressed data 6 and control code 8, the receiving device 24 decompresses the video compressed data 6. Besides showing the compressed way within a predetermined period to the receiving device 24, the control code 8 has the parameters relative to the compression, such as compression radio, and a compression time. The first frame and second frame, decided by the system designer, can be continuous frames or samples in a period. In this embodiment, the high-speed moving image 44 is compressed by MPEG to produce a high-speed moving image compressed data 64 and a relative MPEG control code 84. Animation 42 is compressed by Motion JPEG to produce an animation compressed data 62 and a relative Motion JPEG control code 82. The still frame 40 is compressed by lose-free compression format to produce a still frame compressed data 60 and a lose-free compressed control data 80. When receiving the high-speed moving image compressed data 64, the receiving device 24 can get the information about the MPEG compression format for high-speed moving image compressed data 64 according to the relative control code 84 and then process the relative compression to return the high-speed moving image compressed data 64 back to the high-speed moving image 44 which is then compressed by a specific compression format and sent. Therefore, this method can have smaller amount of transmitting data and provide better frame quality. The other decompressing principles are the same as this one, no tautological detail needed here.

In another embodiment, if the video unit 21 is configured for digitalizing video and the video data for being transmitted is a digital continuous frames, the speed of digitalizing video is 15, 24 to 30 frames, etc according to set. For 30 frames per second here, the transmission time of two continuous frames is 1/30 second which can be compressed by a chosen MPEG format and the compressed data is equal to 1/100 of the original one or less for better transmission through wireless communication system. If the difference of transmitting time between the first frame and the second frame is much larger than 1/30 seconds, the processing unit 22 chooses JPEG format to compress the frame.

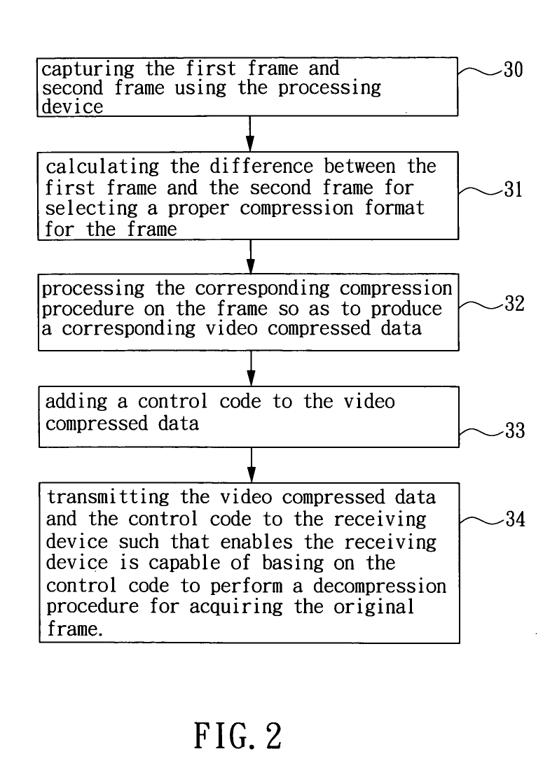

Referring to FIG. 2, the flow diagram of the process of this invention is shown. The method applied to the mentioned system includes:
step 30: capturing the first frame and second frame using the processing device 22;
step 31: calculating the difference between the first frame and second frame, and determining the proper compression format for the frame according to the difference which can be the difference of time or the change of frame, such as MPEG, JPEG, or other compression format known by person skilled in the art in this embodiment;
step 32: processing the corresponding compression procedure on the frame so as to produce a corresponding video compressed data;
step 33: adding a control code to the video compressed data; and
step 34: transmitting the video compressed data and the control code to the receiving device 24 such that enables the receiving device 24 is capable of basing on the control code to perform a decompression procedure for acquiring the original frame.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method for transmitting a video data of a plurality of frames, comprising the steps of:
selecting a compression format for transmitting said plural frames by a decision process;
compressing said video data by said compression format to produce a corresponding video compressed data;
generating a control code with respect to said video compressed data and said compression format; and
transmitting said video compressed data and said control code to a receiving device.

2. The method of claim 1, wherein said receiving device decompresses said video compressed data by said control code in order to get said video data.

3. The method of claim 1, wherein said control code comprises parameters of said compression format and a compression time of said compressed video data.

4. The method of claim 1, wherein said decision process comprises the steps of:
choosing a first frame and a second frame from said plural of frames;
calculating a difference by comparing said first frame and said second frame; and
selecting a compression format for said plural frames according to said difference.

5. The method of claim 4, wherein said first frame and said second frame are continuous frames.

6. The method of claim 4, wherein said video data is compressed by a first compression format when said difference is smaller than a first reference data.

7. The method of claim 6, wherein said video data is compressed by a second compression format when said difference is larger than a second reference data.

8. The method of claim 4, wherein said difference is a difference time of said first frame and said second frame.

9. The method of claim 4, wherein said difference is an image variation between said first frame and said second frame.

10. A device for transmitting a video data to a receiving device, said video data having a plurality of frames, said device comprising:
a video unit for outputting said video data;
a processing unit for coupling to said video unit, said processing unit capturing a portion of said frames and selecting a compression format for said video data, said processing unit generating a compressed video data corresponding to said compression format and generating a control code; and
a transmitting unit coupling to said processing unit, for transmitting said video compressed data and said control code to said receiving device.

11. The device of claim 10, wherein said video unit is an image storage device.

12. The device of claim 10, wherein said control code comprises parameters of said compression format and a compression time of said compressed data.

13. The device of claim 10, wherein said processing unit captures a first frame and a second frame from said plural frames and calculates a difference between said first frame and said second frame to select the compression format for said video data.

14. The device of claim 13, wherein said video data is compressed by a first compression format when said difference is smaller than a first reference data.

15. The device of claim 14, wherein said video data is compressed by a third compression format when said difference is larger than a second reference data.

16. The device of claim 13, wherein said difference is a difference time of said first frame and said second frame.

17. The device of claim 13, wherein said difference is an image variation between said first frame and said second frame.

18. The device of claim 10, wherein said video compressed data is transmitted to said receiving device by wireless.

19. The device of claim 10, wherein said receiving device uses said control code for determining said compression format of said video compressed data so as to proceed with a corresponding decompression process.
